(19) United States
(12) Patent Application Publication
(10) Pub. No.: US 2003/0118045 A1
(43) Pub. Date: Jun. 26, 2003

(54) Computer with a SIM card for identifing users and connecting to communications network

(75) Inventor: Howard Chen, Taipei (TW)

Correspondence Address: BRUCE H. TROXELL, SUITE 1404, 5205 LEESBURG PIKE, FALLS CHURCH, VA, 22041, US

(73) Assignee: Gemtek Technology Co., Ltd.

(21) Appl. No.: 10/230,996

(22) Filed: Aug. 30, 2002

(30) Foreign Application Priority Data
Dec. 26, 2001 (TW) 90132393

(51) Int. Cl. H04L 12/28; H04Q 7/00

(52) U.S. Cl. 370/419; 370/389; 370/328

(57) ABSTRACT

A computer using a SIM card comprises a SIM card interface, a main module, an output device, an input device, and a communication unit. The SIM card interface contains a personal information of a user and his/her identification information for the network. The main module is connected to said SIM card interface for reading and writing the personal information stored in the SIM card, and sending a request signal to the user. The output device is connected to the main module for showing the request signal to the user. The input device is connected to the main module. The communication unit is connected to the main module and the communications network.

### FIELD OF THE INVENTION

The invention relates to a computer with a SIM card, and more particularly, to a computer with a SIM card for identifying users and connecting to communications network.

### BACKGROUND OF THE INVENTION

A SIM card (Subscriber Identification Module) is a card embedded generally and previously in a GMS phone and owned by a mobile operator, making it possible for the operator to identify the customer. The card also contains the features of the subscription. Further, it is possible to save information, such as telephone numbers or text messages, in the SIM card. The telephone numbers and text messages saved by the user in the SIM card can be transferred to a new card.

Personal Identification Number (PIN) is a code used for all GSM based phones to establish authorization for access to certain functions or information. The PIN is provided by the operator with your subscription. The PIN code can be changed.

Personal Identification Number 2 is an authorization code used only for special services available on your GSM handset for e.g. setting Call Charges Meter or Barring Calls through your GSM handset. The PIN2 Code is provided by the operator with your subscription and can be changed.

On the other hand, a wireless LAN (WLAN) is a flexible data communication system implemented as an extension to, or as an alternative for, a wired LAN within a building or campus. Using electromagnetic waves, WLANs transmit and receive data over the air, minimizing the need for wired connections. Thus, WLANs combine data connectivity with user mobility, and, through simplified configuration, enable movable LANs.

Wireless LANs frequently augment rather than replace wired LAN networks-often providing the final few meters of connectivity between a backbone network and the mobile user. Over the last seven years, WLANs have gained strong popularity in a number of vertical markets, including the health-care, retail, manufacturing, warehousing, and academic arenas. These industries have profited from the productivity gains of using hand-held terminals and notebook computers to transmit real-time information to centralized hosts for processing. Today WLANs are becoming more widely recognized as a general-purpose connectivity alternative for a broad range of business customers.

For telecommunication service provider, it is always important to identify the users of public access. On the other hand, as notebook computers and PDAs are getting smaller and thinner, it is also important to have a design for avoid the notebook computers and PDAs from being misused or stolen.

### SUMMARY OF THE INVENTION

The primary object of the invention is to provide a computer with a SIM card for identifying users and connecting to communications network.

Another object of the present invention is to provide a computer with a SIM card.

A computer using a SIM card for identifying users and connecting to communications network is disclosed in the present invention. The computer comprises a SIM card interface, a main module, an output device, an input device, and a communication unit. The SIM card interface is applied to connect to a SIM card, which contains the personal information of a user and his/her identification information for the network. The personal information contains a password predetermined by the user.

The main module is connected to the SIM card interface for reading and writing the personal information stored in the SIM card, and sending a request signal to the user.

The output device is connected to the main module for showing the request signal to the user.

The input device is connected to the main module for receiving a password string input by the user, and sending said password string to the main module. The main module allows the computer to be boosted whenever the password string matches the password. The communication unit is connected to the main module and the communications network.

The communication unit is an Ethernet card, a PCMCIA card, or a wireless telecommunication card providing IEEE 802.11 or blue teeth protocol. The communication unit is not only connected to the main module through a bus, but also connected to the Internet or LAN (Local Area Network). The communication unit enables the computer to access to the information on the Internet or LAN. The communication unit also enables the computer to send the personal information of a user and his/her identification information for the network to the Internet or LAN.

### BRIEF DESCRIPTION OF THE DRAWINGS

FIG. 1 schematically illustrates the block diagram of the computer using a SIM card in accordance with the present invention.

### DESCRIPTION OF THE PREFERRED EMBODIMENTS

The invention relates to a computer with a SIM card, and more particularly, to a computer with a SIM card for identifying users and connecting to communications network.

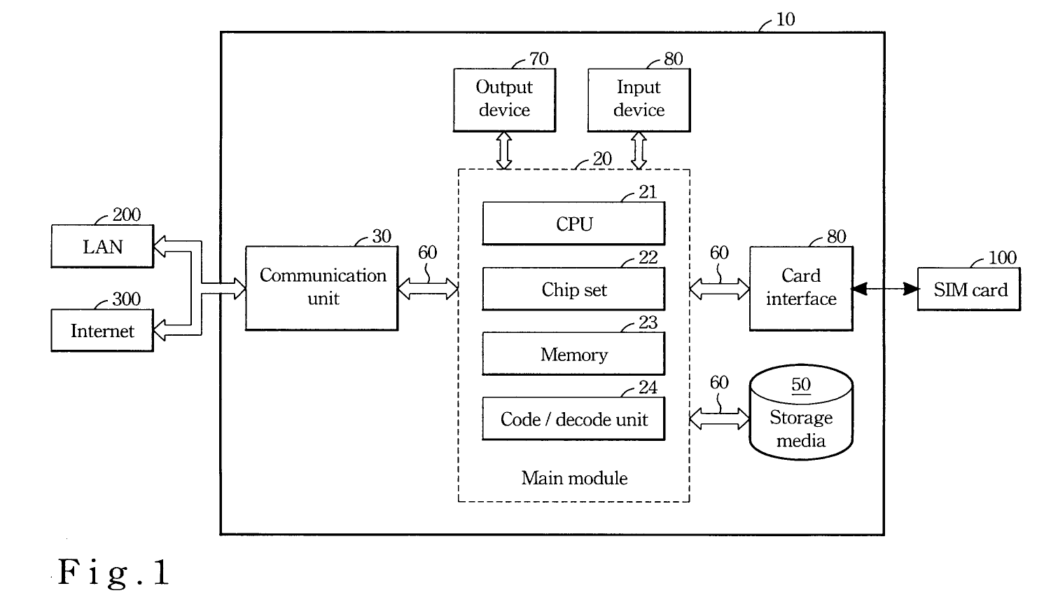

Refer first to FIG. 1, which schematically illustrates the block diagram of the computer with a SIM card in accordance with the present invention. The computer 10 is composed of a SIM card interface 40, a main module 20, an output device 70, an input device 80, a storage media 50, and a communication unit 30.

The SIM card interface 40 is applied to connect to a SIM card 100, which contains the personal information of a user and his/her identification information for the network. The personal information contains a password which is a combination of letters, numbers, and signs, and is predetermined by the user.

The main module 20 is comprised of a CPU 21, a chipset 22, a memory 23, and a code/decode unit 24. The chipset 22 contains a southern bridge and a northern bridge. The memory 23 contains a SRAM (Static Random Access Memory) and a DRAM (Dynamic Random Access Memory). The main module 20, which is connected to the SIM card interface 40 through a bus 60, is applied to read/write the personal information from/to the SIM card 100. The main module 20 can be applied to send a request signal to the user. The main module 20 can also be applied to compare the password string input by the user from the input device 80 to the password stored in the SIM card 100. The main module 20 allows the computer 10 to be boosted whenever the password string matches the password.

The output device 70 is a monitor, which is also connected to the main module 20 through a bus 60. The output device 70 is used to show the request signal to the user.

The input device 80 is a keyboard, a touch panel, a hand-writing panel or a voice input means. The input device 80 is applied to receive the password input by the user, and connected to the main module 20 through a bus 60 in order to send the password to the main module 20.

The storage media 50, which is a hard-disc driver, a floppy driver, a CD-R driver or a MO driver, is connected to the main module 20 through a bus 60 to store any kinds of data.

The communication unit 30 is an Ethernet card, a PCMCIA card, or a wireless telecommunication card providing IEEE 802.11 or blue teeth protocol. The communication unit 30 is not only connected to the main module 20 through a bus 60, but also connected to the Internet 300 or LAN (Local Area Network) 200. The communication unit 30 enables the computer 10 to access to the information on the Internet 300 or LAN 200. The communication unit 30 also enables the computer 10 to send the personal information of a user and his/her identification information for the network to the Internet 300 or LAN 200.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What we claim is:

1. A computer with a SIM card for identifying users and connecting to communications network, comprising:
a SIM card interface, which is applied to connect to a SIM card, which contains the personal information of a user and his/her identification information for the network; wherein said personal information contains a password predetermined by said user;
a main module, which is connected to said SIM card interface for reading and writing said personal information stored in said SIM card, and sending a request signal to said user;
an output device, which is connected to said main module for showing said request signal to said user;
an input device, which is connected to said main module for receiving a password string input by said user, and sending said password string to said main module;
wherein said main module allows said computer to be boosted whenever said password string matches said password; and
a communication unit, which is connected to said main module and said communications network.

2. The computer of claim 1, wherein said communication unit is an Ethernet card.

3. The computer of claim 1, wherein said communication unit is a PCMCIA card.

4. The computer of claim 1, wherein said communication unit is a wireless telecommunication card.

5. The computer of claim 1, wherein said password is a combination of letters, numbers, and signs predetermined by said user.

6. The computer of claim 1, wherein said communications network is the Internet.

7. The computer of claim 1, wherein said communications network is LAN (Local Area Network).

8. The computer of claim 1, wherein said main module contains at least one memory to store said personal information.

9. The computer of claim 8, wherein said memory is a DRAM.

10. The computer of claim 1, wherein said main module is connected to said SIM card interface via a bus.

11. The computer of claim 1, wherein said input device is a keyboard.

12. The computer of claim 1, wherein said input device is a touch panel.

13. The computer of claim 1, wherein said input device is a voice input means.

14. The computer of claim 1, wherein said input device is a hand-writing panel.

15. A computer with a SIM card for identifying users, comprising:
a SIM card interface, which is applied to connect to a SIM card, which contains the personal information of a user and his/her identification information for the network; wherein said personal information contains a password predetermined by said user;
a main module, which is connected to said SIM card interface for reading and writing said personal information stored in said SIM card, and sending a request signal to said user;
an output device, which is connected to said main module for showing said request signal to said user; and
an input device, which is connected to said main module for receiving a password string input by said user, and sending said password string to said main module;
wherein said main module allows said computer to be boosted whenever said password string matches said password.

16. The computer of claim 15, wherein said password is a combination of letters, numbers, and signs predetermined by said user.

17. The computer of claim 15, wherein said main module contains at least one memory to store said personal information.

18. A computer with a SIM card for connecting to communications network, comprising:
a SIM card interface, which is applied to connect to a SIM card, which contains the personal information of a user and his/her identification information for the network; wherein said personal information contains a password predetermined by said user;
a main module, which is connected to said SIM card interface for reading and writing said personal information stored in said SIM card, and sending a request signal to said user; and
a communication unit, which is connected to said main module and said communications network.

19. The computer of claim 18, wherein said communication unit is an Ethernet card.

20. The computer of claim 18, wherein said main module is connected to said SIM card interface via a bus.
